(19) United States
(12) Patent Application Publication
(10) Pub. No.: US 2021/0077954 A1
(43) Pub. Date: Mar. 18, 2021

(54) Method and Apparatus for Onsite Generation and Recovery of Acid and Base Cleaning Solutions

(71) Applicant: Eurodia industrie SAS, Pertuis (FR)

(72) Inventors: Daniel H. Bar, Somerset, NJ (US); Patrick W. Birdsall, Somerset, NJ (US); Ernst Schmidt, Knoxville, TN (US)

(73) Assignee: Eurodia industrie SAS, Pertuis (FR)

(21) Appl. No.: 16/573,481

(22) Filed: Sep. 17, 2019

(51) Int. Cl. B01D 61/54; B01D 61/44; B01D 61/14; B01D 61/02; B01D 61/58

(52) U.S. Cl. CPC B01D 61/54; B01D 61/445; B01D 61/145; B01D 61/027; B01D 2317/025; B01D 2311/04; B01D 2311/246; B01D 2311/243; B01D 61/58

(57) ABSTRACT

Methods and apparatus for onsite generation of acid and base solutions for cleaning purposes through the utilization of bipolar membrane electrodialysis (BPED) are described. The methods eliminate the need to s store large quantities of acids and bases onsite or to transport the acid and base solutions to the cleaning site. A method of recycling substantially neutralized waste salt solutions into acid and base solutions for additional cleaning, thus decreasing the amount of waste salt discharged to the environment, also is described.

### REFERENCE TO RELATED APPLICATIONS

This application claims the benefit of U.S. Provisional Application No. 62/732,744 entitled “Method and Apparatus for Onsite Generation and Recovery of Acid and Base Cleaning Solutions” filed Sep. 18, 2018, which is incorporated by reference in its entirety.

### BACKGROUND

In many industrial cleaning applications, highly alkaline (basic or caustic) and highly acidic cleaning compositions must be transported, handled and applied by workers. However, such compositions can be dangerous and can cause burns to exposed skin, particularly in the concentrated form. While more concentrated acid/base solutions may reduce transportation costs, the likelihood of injury increases from transporting the highly concentrated solutions or solids.

A typical industrial cleaning process requires large amounts of water, chemicals and energy. Rising chemical costs and disposal of caustic and acid solutions is becoming increasingly unacceptable. Industries are challenged to find ways to comply with increasingly stringent regulatory requirements. Thus, onsite acid/base solution generation, recovery, and re-generation is desirable.

Clean-in-Place (CIP) is the procedure for cleaning by circulating water and chemicals through sections (called circuits) of an industrial plant. These CIP units are fed by a common acid and alkali tank, where a chemical concentrate is diluted to the desired concentration for cleaning. The cleaning cycle is commonly initially alkaline, and then acidic. The acidic cycle may be followed by a disinfection cycle. With an increasing number of cleaning cycles, there is also an increasing number of intermediate rinses s between the cleaning cycles. Typically, dilute hot caustic and dilute hot acid solutions are applied to remove protein fouled surfaces and hardness deposits.

Electrolysis cells previously have been used in sanitizing applications. These cells have different configurations, namely divided and undivided. Divided electrolysis cells are used to create anolyte and catholyte liquids. Anolyte liquids have known sanitizing properties, and catholyte liquids have known cleaning properties. Undivided electrolysis cells provide a mixed oxidant for sterilizing. See, for example, U.S. Pat. Pubs. 2011/0067732 and 2012/0228145.

In electrodialysis, gases are not formed nor consumed. This is in direct contrast to electrolysis were water splits into hydrogen gas and oxygen gas at the cathode and anode electrodes, respectfully. Instead of charged electrodes, electrodialysis uses bipolar membranes in the electrodialysis cells that are a special type of layered ion exchange membrane. The membranes consist of two polymer layers carrying fixed charges, where one polymer layer is only permeable for the anions while the other polymer membrane is only permeable for the cations. The anions and cations arise from a disproportionation reaction occurring in the bipolar junction of the membrane where the anion and the cation permeable layers are in direct contact. Thus, instead of being split into hydrogen and oxygen gases, as in electrolysis, water is split into hydroxide ions and protons in the bipolar junction of the electrodialysis membrane. The produced hydroxide ions and protons separate by migration through the respective permeable membrane layer out of the membrane.

Bipolar membrane electrodialysis can be useful if either the acid or the base is the desired product. The process has applications for the regeneration of ion-exchange resins and for pH control in water, chemical and biochemical reactions. See, for example, U.S. Pat. Nos. 5,352,345 and 6,221,225.

There is a need to produce acid and base solutions of moderate strength onsite to avoid the aforementioned and other issues for economic, safety, and environmental reasons. The present invention avoids or ameliorates at least some of the disadvantages of conventional devices and methods, especially in the context of producing non-oxidizing alkali and acidic cleaning compositions that boost performance in an economically and environmentally beneficial manner.

### SUMMARY

In one aspect, the invention provides a method of generating acid and base cleaning solutions onsite from a salt solution by bipolar membrane electrodialysis, the method including circulating a mineral-containing salt solution through a bipolar membrane electrodialysis stack to produce a partially depleted salt solution, an acid solution, and a base solution; directing the acid solution to an acid tank; directing the base solution to a base tank; directing the partially depleted salt solution from the bipolar electrodialysis stack back to a salt solution circulating tank; monitoring a salt concentration of the circulating mineral-containing salt solution and; directing a near saturated salt solution from a brine tank into the circulating mineral-containing salt solution to increase and maintain a salt concentration of the partially depleted salt solution.

Other systems, methods, features and advantages of the invention will be, or will become, apparent to one with skill in the art upon examination of the following figures and detailed description. It is intended that all such additional systems, methods, features, and advantages be included within this description, be within the scope of the invention, and be protected by the claims that follow. The scope of the present invention is defined solely by the appended claims and is not affected by the statements within this summary.

### BRIEF DESCRIPTION OF THE FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 represents a system for generating acid and base solutions onsite from a salt solution.

FIG. 2 represents a system where the system for generating acid and base solutions onsite from a salt solution is supplemented so neutralized spent cleaning solutions may be filtered and reused to regenerate acid and base solutions.

### DETAILED DESCRIPTION

Methods and apparatus for onsite generation of acid and base solutions for cleaning purposes through the utilization of bipolar membrane electrodialysis (BPED) are described. The methods eliminate the need to store large quantities of acids and bases onsite or to transport the acid and base solutions to the cleaning site. A method of recycling substantially neutralized waste salt solutions into acid and base solutions for additional cleaning, thus decreasing the amount of waste salt discharged to the environment, also is described.

The following description references the splitting of a potassium nitrate (KNO₃) salt solution to generate a nitric acid (HNO₃) solution and a potassium hydroxide (KOH) solution. However, the selection of other salt solutions and salt solution mixtures may be used to generate different acid/base solutions for cleaning. For example, sodium nitrate (NaNO₃) may be used to produce nitric acid and sodium hydroxide (NaOH) cleaning solutions, or a mixture of potassium nitrate and sodium nitrate may be used to produce nitric acid and a combination of potassium and sodium hydroxide for cleaning. As a base, KOH is favored over NaOH as being more alkali than NaOH and forming salts have a greater solubility in water than NaOH derived salts. Additionally, wastewater containing potassium salt has less impact on the environment than its sodium-based counterpart. While phosphate and sulfate salts may be used, they generally are not preferred due to the release of phosphorous to the wastewater and the corrosiveness of sulfuric acid.

A volume of brine, thus a mineral-salt solubilized in water to form a near saturated salt solution, preferably having a concentration of 10-25 wt. % mineral-salt, is maintained in a brine tank. Dry crystalline salt, preferably KNO₃, and demineralized water from a suitable source is periodically added to the brine tank as the initial volume is depleted during the cleaning process. A brine softener containing chelating resins may be positioned to remove multi-valent ions, such as calcium and magnesium ions, and other contaminants, from the brine solution.

In a three-compartment BPED stack, the salt, acid and base streams are distributed between membranes that are stacked in repeating sequences called repeat units. Anions are transported across the anion permeable membrane, cations are transported across the cation permeable membrane, and the production of protons and hydroxide ions occurs in the bipolar membrane. The generated hydroxide ions and protons move towards the (positive) anode and the (negative) cathode, respectively, by means of migration in an electrical field. Ideally, the ions are trapped in the compartments adjacent to the two sides of the bipolar membrane in the respective base and acid compartments, which results in the concentration of the formed acid in a first adjacent compartment and the concentration of the formed base in a second adjacent compartment. Thus, in addition to separating the positive and negative ions of the salt into the separate compartments, the BPED stack also splits water into H+ and OH− ions that also are separated into the compartments. In this way, the concentrated acid solution exits the BPED stack from the first adjacent compartment, the concentrated base solution exits the BPED stack from the second adjacent compartment, and the remaining partially depleted salt solution exits the BPED from a central compartment.

The separated NO₃ and H+ ions generated at the bipolar membrane form HNO₃, which is directed to an acid loop or tank. The separated K+ and the OH⁻ ions generated at the bipolar membrane form potassium hydroxide (KOH), which is directed to a base loop or tank.

When the acid and base solutions reach predetermined concentrations, they may be transferred from their respective tanks to a corresponding bulk storage or “day” tank or directly to a cleaning circuit.

After being used for cleaning process equipment, partially or substantially neutralized, salt laden cleaning solutions may be recovered, electrolytically reconverted, and then reused within the plant for additional cleaning. To reuse the salt laden cleaning solutions, the salt laden cleaning solutions are first clarified using pressure driven membranes to remove suspended and dissolved solids. Ultrafiltration pressure driven membranes may be applied to remove suspended solids and nanofiltration pressure driven membranes may be used to remove low molecular weight organic matter and inorganic contaminants. The nanofiltration permeate is then directed to a conventional electrodialysis (ED) unit to concentrate the salt in the salt laden cleaning solution. Unlike the BPED stack, the ED unit does not split water or separate positive and negative ions—instead the ED concentrates the salt, thus removing water from the salt solution. The ED concentrated salt solution is then sent back to the brine tank for acid and base production.

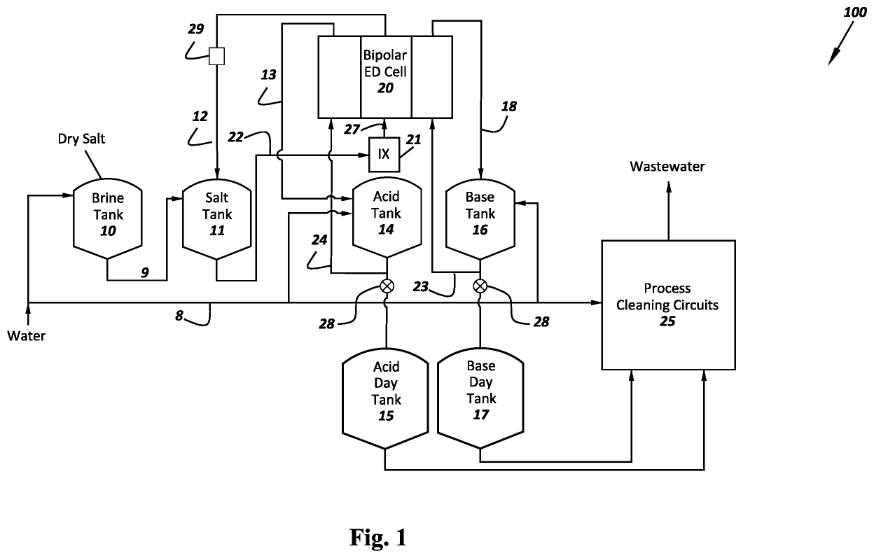

FIG. 1 represents a system 100 for generating acid and base solutions onsite from a salt solution. The system 100 includes a near saturated salt solution in a brine tank 10 in fluid communication with a salt solution circulating tank 11 by brine tank outlet line 9. The salt solution circulating tank 11 is in fluid communication with a bipolar electrodialysis cell 20 by salt tank circulation line 12. The bipolar electrodialysis cell 20 is in fluid communication with an acid tank 14 by acid tank inlet line 13. The bipolar electrodialysis cell stack 20 is in fluid communication with base tank 16 by base tank inlet line 18. The acid tank 14 is in fluid communication with an acid product day tank 15, while the base tank 16 is in fluid communication with a base product day tank 17.

The stack 20 generally includes multiple cells typically assembled to form an electrodialysis stack (not shown). Direct current is input to the stack 20 via two electrodes at the ends of the stack 20 to initiate the disproportionation reaction.

A salt solution from the salt solution circulating tank 11 is circulated into the compartments between the anion and cation membranes of the stack 20 via the salt tank circulation line 12. The partially depleted salt solution from the salt loop compartments between the anion and cation membranes of the stack 20 is circulated back into the salt solution circulating tank 11 via the salt tank circulation line 12. The concentration of the partially depleted salt solution is monitored by a conductivity monitor 29. The conductivity monitor 29 may be placed in the salt tank circulation line 12, or at another location to monitor the conductivity of the partially depleted salt solution.

In response to the conductivity monitor 29, the concentration of the salt solution entering the stack 20 and the concentration of the partially depleted salt solution exiting the stack 20 through the salt tank circulation line 12 may be maintained at a preselected level via the flow through the brine tank outlet line 9. The preselected level of the partially depleted salt concentration maintained is from 2 to 25 percent by weight, preferably from 10 to 25 percent by weight, and more preferably from 15 to 25 percent by weight.

The acid HNO₃ solution generated in the compartments between the anion membranes and the bipolar membranes of the stack 20 is directed into the acid tank 14 via the acid tank inlet line 13. The base KOH solution generated in the compartments between the cation membranes and the bipolar membranes of the stack 20 is directed into the base tank 16 via the base tank inlet line 18. The efficiency of the stack 20 may be maximized when the concentration of the salt solution entering the stack 20 from the salt solution circulating tank 11 is approximately 10% by weight and greater.

The system 100 includes the brine tank 10 into which crystalline salt is added with water to maintain a saturated brine solution. A brine tank level monitor may be used to monitor the level of the brine in the brine tank 10. The crystalline salt is preferably dry KNO₃, while the water is preferably demineralized water.

An optional brine softener 21 including chelating resins, such as AMBERLITE IRC748, DIAION CR11, and the like, may be positioned in fluid communication after the salt solution circulating tank 11 via a softener inlet line 22 and before the stack 20 via a softener outlet line 27. When present, the brine softener 21 removes multi-valent ions, such as calcium and magnesium ions, from the salt solution.

The acid solution produced from the stack 20 is directed into the acid tank 14 via the acid tank inlet line 13 and circulated back through the compartments between the bipolar membranes and the anion exchange membranes of the stack 20 via the acid tank recirculation line 24. The circulation of the acid solution from the acid tank 14 back into the stack 20 increases the concentration of the circulating acid solution. Similarly, the base solution from stack 20 is directed into the base tank 16 via the base tank inlet line 18 and circulated back through the compartments between the bipolar membranes and the cation exchange membranes of the stack 20 via the base tank recirculation line 23. The circulation of the base solution from the base tank 16 back into the stack 20 increases the concentration of the circulating base solution. Conductivity is used to monitor and control concentration of acid and base solutions.

When the solutions in the base and acid tanks 16, 14 reach a predetermined conductivity value relatable to a known concentration, control valve 28 opens to direct concentrated base solution from the base tank 16 into the base cleaning day tank 17 for cleaning use, and also directs concentrated acid solution from the acid tank 14 into the acid cleaning day tank 15 for cleaning use. These concentrated solution transfers reduce the liquid level in the base and acid tanks 16, 14. The control valve may be a single valve or multiple valves and may be operated, manually, electrically, hydraulically, pneumatically, and the like. The predetermined conductivity value for the base tank 16 may be from 50 to 450 mS/cm, for example, depending on the base, with values from 80 to 250 mS/cm preferred for KOH and with values from 100 to 230 mS/cm being preferred for NaOH. The predetermined conductivity value for the acid tank 14 may be, for example, from 100 to 500 mS/cm, with values from 150 to 300 mS/cm being preferred for nitric acid.

A level switch is activated to close the control valve to terminate flow into the tanks 16, 14 and to then open a water delivery valve (not shown) to deliver water from water line 8 into the tanks 16, 14. The water entering the base tank 16 and the acid tank 14 increases the liquid level in the tanks until the liquid level reaches and activates a switch to close the water delivery valve, thereby terminating the flow of water from the water line 8 into the tanks 16, 14.

The product acid solution (concentrated and diluted in the acid tank 14) is then directed into the acid day tank 15. The product base solution (concentrated and diluted in the base tank 16) is also directed into the base day tank 17. The product acid and base solutions then may be used as cleaning solutions in process cleaning circuits 25. The process cleaning circuits 25 may include centralized cleaning stations, decentralized cleaning stations, or the like. If desired, a wetting agent, such as sodium triphosphate, may be added to the base circuit to assist in caustic cleaning. Other agents may be added to the generated acid and or base cleaning solutions to assist in the cleaning process.

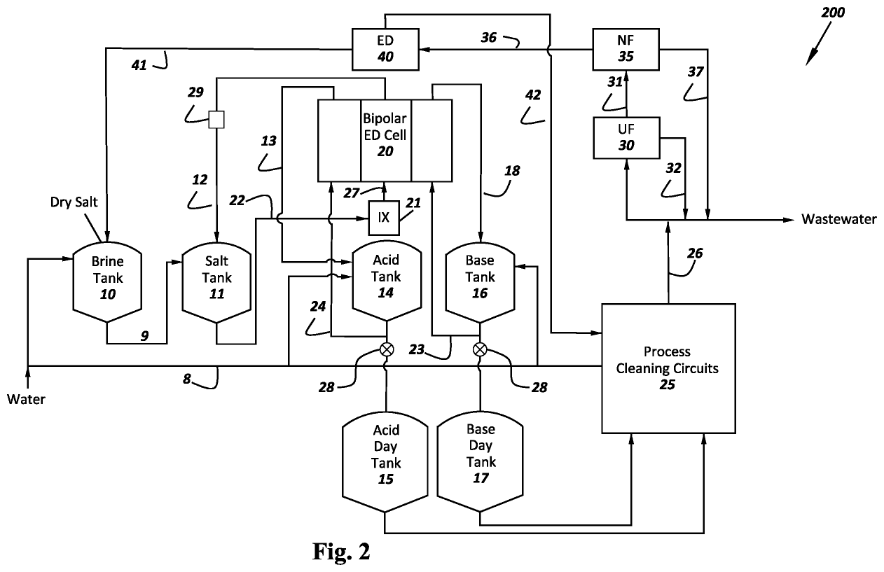

FIG. 2 represents system 200 where the system for generating acid and base solutions onsite from a salt solution, such as previously described in relation to FIG. 1, is supplemented so neutralized spent cleaning solutions may be filtered and reused to regenerate acid and base solutions. In the system 200, neutralized spent cleaning solutions and water rinses from the process cleaning circuits 25 may be directed to an ultrafiltration (UF) unit 30 via spent cleaning solution recapture line 26. The UF unit 30 may retain suspended solids, colloids, high molecular weight organic compounds, and some bacteria, but preferably allows low molecular weight compounds, such as sugars, salts and color-causing compounds, to pass through. Thus, a suspension enters the UF unit 30 to produce a filtrate solution. The ultrafiltration unit 30 retentate line 32 is directed to wastewater.

The UF filtrate solution from the ultrafiltration unit 30 may then be fed into a nanofiltration (NF) unit 35 via nanofiltration inlet line 31. The nanofiltration unit 35 reduces the solution concentration of color-causing compounds and also reduces the chemical oxygen demand (COD) of the solution. The nanofiltration unit 35 is particularly useful in significantly reducing the solution concentration of undesirable ions, such as sulfate, phosphate, calcium, magnesium, aluminum, and silica monovalent and divalent ions in the UF filtrate. Additives such as sequestrants are molecules that also may be removed by the nanofiltration unit 35. The nanofiltration unit 35 retentate line 37 is directed to wastewater.

The nanofiltration permeate is then directed to an electrodialysis (ED) unit 40 via electrodialysis inlet line 36 to preconcentrate the salt solution recovered from the process cleaning circuits 25. ED is an especially attractive technology for treating water with high nitrate levels. The ED unit 40 includes a pair of electrodes configured to act as an anode and a cathode. A plurality of alternating anion-permeable and cation-permeable membranes are disposed between the anode and the cathode to form a series of alternating dilute and concentrate channels between the membranes. The anion-permeable membranes allow the passage of anions through the membrane, while the cation-permeable membranes allow the passage of cations through the membrane. Both membrane types preferably selectively pass univalent ions while rejecting multivalent ions. Use of such preferred univalent-selective membranes in the ED unit 40 provides the desirable benefit of higher KNO₃ concentrations being generated by the electrodialysis unit 40.

ED preconcentrate, from the ED unit 40 is directed to the brine tank 10 via ED preconcentrate line 41, for acid and base regeneration from the ED preconcentrate salt solution. The substantially desalted ED diluate from the ED unit 40 may be passed through ED diluate line 42 back to the process cleaning circuits 25 for use as a pre-rinse water.

While various aspects of the invention are described, it will be apparent to those of ordinary skill in the art that other embodiments and implementations are possible within the scope of the invention. Accordingly, the invention is not to be restricted except by the attached claims and their equivalents.

The simplified diagrams and drawings do not illustrate all the various connections and assemblies of the various components, however, those skilled in the art will understand how to implement such connections and assemblies, based on the illustrated components, figures, and descriptions provided herein, using sound engineering judgment.

1. A method of generating acid and base cleaning solutions onsite from a salt solution by bipolar membrane electrodialysis, the method comprising:
circulating a mineral-containing salt solution through a bipolar membrane electrodialysis stack to produce a partially depleted salt solution, an acid solution, and a base solution;
directing the acid solution to an acid tank;
directing the base solution to a base tank;
directing the partially depleted salt solution from the bipolar electrodialysis stack back to a salt solution circulating tank;
monitoring a salt concentration of the circulating mineral-containing salt solution and;
directing a near saturated salt solution from a brine tank into the circulating mineral-containing salt solution to increase and maintain a salt concentration of the partially depleted salt solution.

2. The process of claim 1, where a mineral salt in the near saturated salt solution is selected from the group consisting of potassium nitrate, sodium nitrite, and combinations thereof.

3. The method of claim 1, where the partially depleted salt solution includes a lower salt concentration than the near saturated salt solution.

4. The method of claim 1, where the partially depleted salt solution has a salt concentration from 2% to 25% by weight.

5. The method of claim 1, further comprising circulating the acid solution from the acid tank and the base solution from the base tank through the bipolar membrane electrodialysis stack to increase acid concentration of the acid solution and to increase base concentration of the base solution, respectively.

6. The method of claim 1, further comprising monitoring a concentration of the acid solution entering the acid tank, a concentration of the base solution entering the base tank, or both.

7. The method of claim 6, further comprising withdrawing a portion of the acid solution from the acid tank when the concentration of the acid solution in the acid tank reaches an acid tank predetermined conductivity value.

8. The method of claim 7, where the predetermined conductivity value is from 100 to 500 mS/cm.

9. The method of claim 6, further comprising withdrawing a portion of the base solution from the base tank when the concentration of the base solution in the base tank reaches a base tank predetermined conductivity value.

10. The method of claim 9, where the predetermined conductivity value is from 50 to 450 mS/cm.

11. The method of claim 9, where the predetermined conductivity value is from 80 to 250 mS/cm.

12. The method of claim 9, where the predetermined conductivity value is from 100 to 230 mS/cm.

13. The method of claim 1, further comprising ultrafiltering a neutralized cleaning solution including suspended solids from process cleaning circuits to produce an ultrafiltered neutralized cleaning solution.

14. The method of claim 13, further comprising nanofiltering the ultrafiltered neutralized cleaning solution to reduce the ion concentration of the ultrafiltered neutralized cleaning solution to produce a nanofiltered neutralized cleaning solution.

15. The method of claim 14, further comprising preconcentrating the nanofiltered neutralized cleaning solution with electrodialysis using ion selective membranes to form an electrodialysis preconcentrate and an electrodialysis diluate.

16. The method of claim 15, where the ion selective membranes are univalent ion selective membranes.

17. The method of claim 15, further comprising returning the electrodialysis preconcentrate solution to the brine tank.

18. The method of claim 15, further comprising returning the electrodialysis diluate to the process cleaning circuits.
